(19) United States
(12) Patent Application Publication
(10) Pub. No.: US 2011/0226090 A1
(43) Pub. Date: Sep. 22, 2011

(54) TRANSMISSION MODULE OF BIKE

(75) Inventor: Ching-Lu Hsu, Taipei County (TW)

(73) Assignee: GEE HOO FITEC CORP., Taipei County (TW)

(21) Appl. No.: 12/774,441

(22) Filed: May 5, 2010

(30) Foreign Application Priority Data
Mar. 17, 2010 (TW) 99204699

(51) Int. Cl. F16H 3/00

(52) U.S. Cl. 74/810.1

(57) ABSTRACT

A power system of a bike includes a transmission module and a driven module. The transmission module includes a main shaft, on which a transmitting gear and a driving gear are located. Two one-way bearings are provided between the transmitting gear and the main shaft and between the driving gear and the main shaft. The one-way bearings are oppositely arranged. A driven gear is meshed with the transmitting gear and connected to the driving gear through a belt that the driven gear will be turned in a predetermined direction when the main shaft is turned in both directions. The driven module includes a wheel and a belt wound around the driving gear and the wheel that the wheel is turned synchronously.

### BACKGROUND OF THE INVENTION

1. Field of the Invention

The present invention relates generally to a mechanism for driving wheel, and more particularly to a transmission module of a bike.

2. Description of the Related Art

Typically, a conventional transmission mechanism for driving a wheel includes a gear to be turned and a belt winding around the wheel. Such transmission mechanism usually is incorporated in a rehabilitation device or a bike, in which the gear of the transmission mechanism is turned by a crank, and the wheel is equipped with a damping device to provide loading. With these, user may take exercise on the rehabilitation device or the bike to train predetermined muscles.

However, these rehabilitation devices or bikes equipped with the transmission mechanism only work when the user steps the crank in a predetermined direction, such as clockwise. The damping device will not work when the user steps the crank in a reverse direction, such as counterclockwise. Sometimes, user may have to turn the crank in the reverse direction for a specific purpose, and the conventional rehabilitation device or bike can't provide such function.

### SUMMARY OF THE INVENTION

The primary objective of the present invention is to provide a transmission module of a bike, which may transmit a power to drive a wheel turning in a direction no matter user steps the bike in a forward direction or a backward direction.

According to the objective of the present invention, a power system of a bike includes a transmission module having an active unit including a main shaft to be driven to rotation in a forward direction and a backward direction, a transmitting gear mounted on the main shaft, a driving gear mounted on the main shaft, a first one-way clutch between the transmitting gear and the main shaft, and a second one-way clutch between the driving gear and the main shaft; and a passive unit including a positioning shaft, a driven gear, which is mounted on the positioning shaft, meshed with the transmitting gear of the active unit and connected to the driving gear of the active unit.

The transmission module may be connected to a driven module including a wheel and a belt wound around the driving gear of the transmission module and the wheel. The transmitting gear of the transmission module is driven to rotate in the forward direction through the first one-way clutch to drive the wheel of the driven module to rotate in the backward direction when the main shaft rotates in the forward direction, and the driving gear of the transmission module is driven to rotate in the backward direction through the second one-way clutch to drive the wheel of the driven module to rotate in the backward direction when the main shaft rotates in the backward direction.

In an embodiment, the first and second one-way clutches are one-way bearings.

### BRIEF DESCRIPTION OF THE DRAWINGS

FIG. 1 is a sketch diagram of the power system of the bike of a preferred embodiment of the present invention;

FIG. 2 is an exploded view of the transmission module of the power system of the preferred embodiment of the present invention;

FIG. 3 is a perspective view of the transmission module of the power system of the preferred embodiment of the present invention;

FIG. 4 is a top view of FIG. 3;

FIG. 5 is a sectional view of FIG. 4; and

FIG. 6 is a sketch diagram, showing the action of the power system.

### DETAILED DESCRIPTION OF THE INVENTION

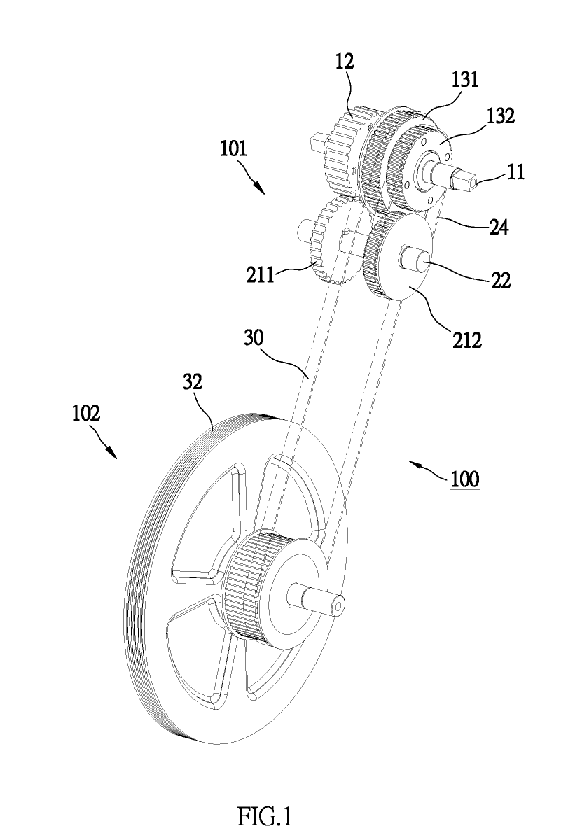

As shown in FIG. 1, a power system 100 of a bike includes a transmission module 101 and a driven module 102.

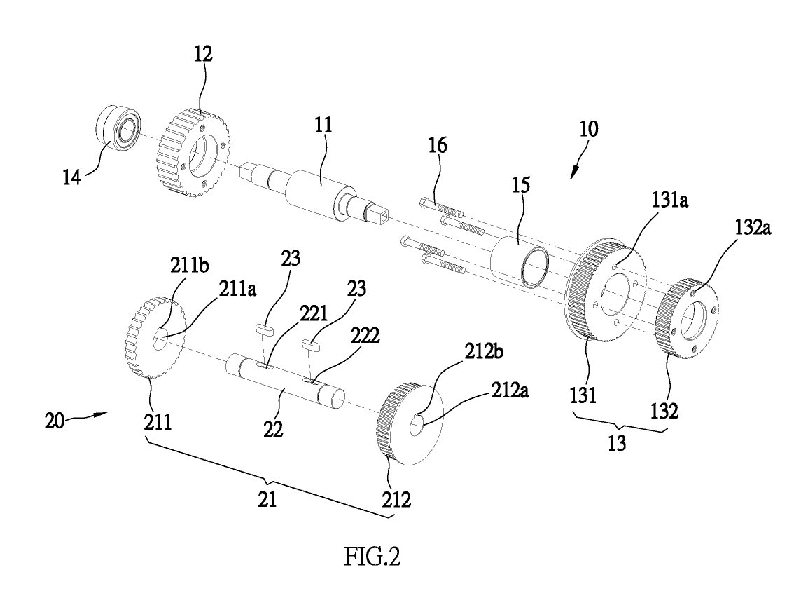

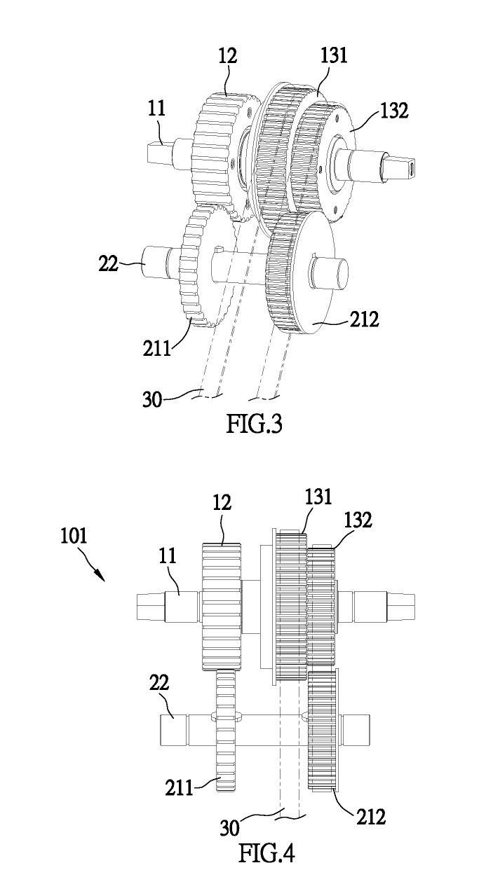

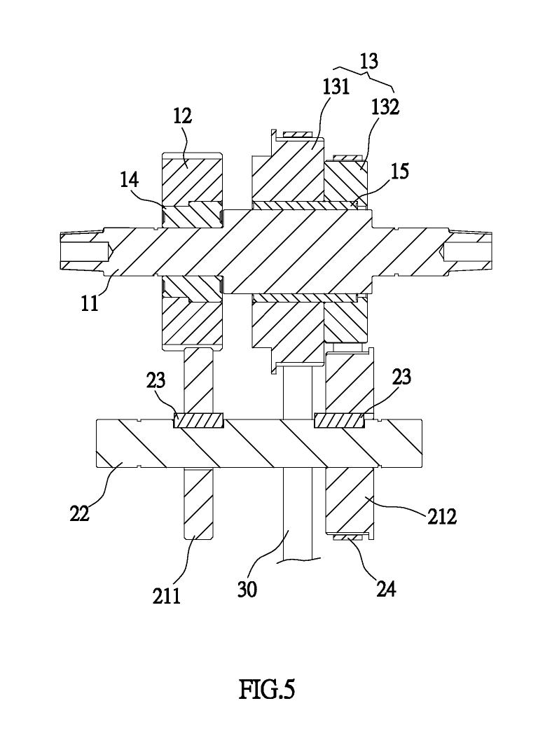

As shown in FIG. 2 to FIG. 5, the transmission module 101 includes an active unit 10 and a passive unit 20.

The active unit 10 includes a main shaft 11, a transmission gear 12, a driving gear 13, a first one-way clutch 14, and a second one-way clutch 15.

The transmission gear 12 and the driving gear 13 are mounted on the main shaft 11, and the main shaft 11 may be driven for rotation in a forward direction and a backward direction.

The first one-way clutch 14 is between the transmitting gear 12 and the main shaft 11. In the present embodiment, the first one-way clutch 14 is a one-way bearing that the transmitting gear 12 is driven by the main shaft 11 to rotate in the forward direction when the main shaft 11 rotates in the forward direction, and the transmitting gear 12 doesn't rotate when the main shaft 11 rotates in the backward direction.

In the present embodiment, the driving gear 13 includes a first gear 131 and a second gear 132. The first gear 131 includes a plurality of holes 131a, and the second gear 132 includes a plurality of threaded holes 132a. Bolts 16 pass through the holes 131a of the first gear 131, and are screwed into the threaded holes 132a of the second gear 132 that the first gear 131 and the second gear 132 are connected together and rotate synchronously.

The second one-way clutch 15 is between the main shaft 11 and the first and second gears 131, 132. In the present embodiment, the first one-way clutch 14 is a one-way bearing also that the first and second gears 131, 132 are driven by the main shaft 11 to rotate in the backward direction when the main shaft 11 rotates in the backward direction, and the first and second gears 131, 132 don't rotate when the main shaft 11 rotates in the forward direction.

The passive unit 20 includes a driven gear 21, a positioning shaft 22, two pins 23, and a belt 24.

The driven gear 21 includes a first gear 211 and a second gear 212. The first gear 211 has a central hole 211a with a slot 211b on a sidewall thereof. The second gear 212, similar to the first gear 211, has a central hole 212a with a slot 212b on a sidewall thereof.

The positioning shaft 22, which has two slots 221, 222, passes through the central holes 211a, 212a of the first and second gears 211, 212 with the slots 221, 222 aligned with the slot 211b, 212b of the first and second gears 211, 212 respectively.

The pins 23 are received in the slots 221, 222, 211b, 212b of the positioning shaft 22 and the first and second gears 211, 212 respectively to fix the first and second gears 211, 212 to the positioning shaft 22 that the positioning shaft 22 and the first and second gears 211, 212 rotate synchronously. The first gear 211 is meshed with the transmitting gear 12 of the active unit 10.

The belt 24 is wound around the second gear 212 and the second gear 132 of the active unit 10.

In the present embodiment, the driven module 102 includes a belt 30 and a wheel 32. As shown in FIG. 1, the belt 30 is wound around the driving gear 13 of the active unit 10 and the wheel 32.

The power system 100 of the present invention may be incorporated in a rehabilitation device or a bike. Two cranks (not shown) is mounted at opposite ends of the main shaft 11 of the transmission module 101 to be turned by a user's hands or feet in the forward direction and the backward direction.

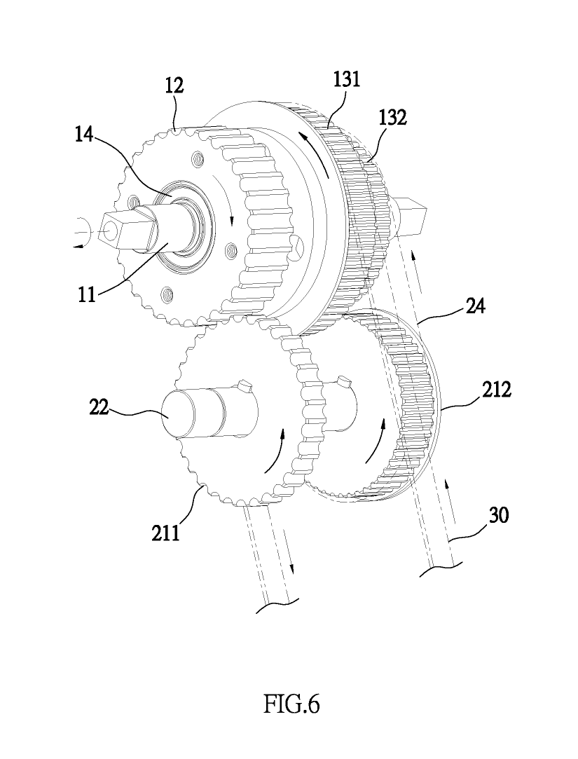

As shown in FIG. 6, when the main shaft 11 is turned in the forward direction, the transmitting gear 12 is turned in the forward direction through the one-way bearing 14 and the first gear 211, which is meshed with the transmitting gear 12, and the second gear 212 of the driven gear 21 are turned in the backward direction, and then the second gear 132, which is connected to the second gear 212 through the belt 24, and the first gear 131 of the driving gear 13 is turned in the backward direction to drive the wheel to rotate in the backward direction through the belt 30.

On the contrary, when the main shaft 11 is turned in the backward direction, the first gear 131 and the second gear 132 of the driving gear 13 are turned in the backward direction through the one-way bearing 15 to drive the wheel to rotate in the backward direction through the belt 30. In this condition, the transmitting gear 12 is driven to rotate in the forward direction through the belt 24, the second gear 212 of the driven gear 21, the positioning shaft 22, and the first gear 211 of the driven gear 21. However, the main shaft 11 will not be driven by the transmitting gear 12 because of the one-way bearing 14.

In conclusion, the wheel 32 will be driven to rotate in the backward direction no matter when the main shaft 11 is turned in the forward direction or in the backward direction.

When the power system 100 of the present invention is incorporated in a rehabilitation device or a bike, the wheel 32 may include a flywheel and a damping device (not shown) to provide a predetermined loading when a user uses the rehabilitation device or the bike for training muscles.

The description above is a few preferred embodiments of the present invention and the equivalence of the present invention is still in the scope of claim construction of the present invention.

What is claimed is:

1. A transmission module, comprising:
an active unit including a main shaft to be driven to rotate in a forward direction and a backward direction, a transmitting gear mounted on the main shaft, a driving gear mounted on the main shaft, a first one-way clutch between the transmitting gear and the main shaft, and a second one-way clutch between the driving gear and the main shaft; and
a passive unit including a positioning shaft, a driven gear, which is mounted on the positioning shaft, meshed with the transmitting gear of the active unit and connected to the driving gear of the active unit;
wherein the transmitting gear is driven to rotate in the forward direction through the first one-way clutch when the main shaft rotates in the forward direction, and the driving gear is driven to rotate in the backward direction through the second one-way clutch when the main shaft rotates in the backward direction.

2. The transmission module as defined in claim 1, wherein the driving gear of the active unit includes a first gear and a second gear for synchronously rotating, and the driven gear of the passive unit includes a first gear, which is meshed with the transmitting gear, and a second gear for synchronously rotating, and the passive unit further includes a belt wound around the second gear of the driven gear and the second gear of the driving gear.

3. The transmission module as defined in claim 1, wherein the first gear and the second gear of the driving gear are connected together by bolts.

4. The transmission module as defined in claim 1, wherein the first one-way clutch is a one-way bearing.

5. The transmission module as defined in claim 1, wherein the second one-way clutch is a one-way bearing.

6. A power system of a bike, comprising:
a transmission module including an active unit including a main shaft to be driven to rotate in a forward direction and a backward direction, a transmitting gear mounted on the main shaft, a driving gear mounted on the main shaft, a first one-way clutch between the transmitting gear and the main shaft, and a second one-way clutch between the driving gear and the main shaft; and a passive unit including a positioning shaft, a driven gear, which is mounted on the positioning shaft, meshed with the transmitting gear of the active unit and connected to the driving gear of the active unit; and
a driven module including a wheel and a belt wound around the driving gear of the transmission module and the wheel;
wherein the transmitting gear of the transmission module is driven to rotate in the forward direction through the first one-way clutch to drive the wheel of the driven module to rotate in the backward direction when the main shaft rotates in the forward direction, and the driving gear of the transmission module is driven to rotate in the backward direction through the second one-way clutch to drive the wheel of the driven module to rotate in the backward direction when the main shaft rotates in the backward direction.

7. The power system as defined in claim 6, wherein the driving gear of the active unit includes a first gear and a second gear for synchronously rotating, and the driven gear of the passive unit includes a first gear, which is meshed with the transmitting gear, and a second gear for synchronously rotating, and the passive unit further includes a belt wound around the second gear of the driven gear and the second gear of the driving gear.

8. The power system as defined in claim 6, wherein the first one-way clutch is a one-way bearing.

9. The power system as defined in claim 6, wherein the second one-way clutch is a one-way bearing.
